(19) United States
(12) Patent Application Publication
(10) Pub. No.: US 2026/0051238 A1
(43) Pub. Date: Feb. 19, 2026

(54) NEIGHBORHOOD ALARM NETWORK

(71) Applicant: TRONG NGUYEN, San Jose, CA (US)

(72) Inventor: TRONG NGUYEN, San Jose, CA (US)

(21) Appl. No.: 18/805,971

(22) Filed: Aug. 15, 2024

(51) Int. Cl. G08B 25/10; G06F 3/0484; G08B 13/183

(52) U.S. Cl. CPC G08B 25/10; G08B 13/183; G06F 3/0484

(57) ABSTRACT

The Neighborhood Alarm Network is a coordinated security network designed to protect residential areas through collective vigilance. It integrates twin photobeam detectors, outdoor alarm sirens, a mesh network gateway, a local automation server, and a customizable user interface to detect intrusions and trigger alarm sirens across multiple households. The system allows for remote management and customization, providing a robust and flexible solution for enhancing neighborhood security.

### FIELD OF THE INVENTION

The present invention relates to a coordinated neighborhood security system designed to detect intrusions and trigger alarm sirens across multiple households, providing an effective method for alerting residents and deterring intruders.

### BACKGROUND OF THE INVENTION

Security concerns in residential areas have necessitated the development of systems that not only protect individual properties but also foster community safety through collective vigilance. The Neighborhood Alarm Network addresses these concerns by integrating household security devices with a centralized control system to create a coordinated alarm response network.

### SUMMARY OF THE INVENTION

The Neighborhood Alarm Network consists of twin photobeam detectors, outdoor alarm sirens, a mesh network gateway, a local automation server, and a customizable user interface. The system is designed to detect intrusions and trigger a series of alarm sirens across a predefined network of households, allowing for remote management and customization via an Internet-connected interface.

### BRIEF DESCRIPTION OF THE DRAWINGS

The accompanying drawings illustrate the Neighborhood Alarm Network, detailing the arrangement and interaction of its components.

FIG. 1: Neighborhood Alarm Network Layout

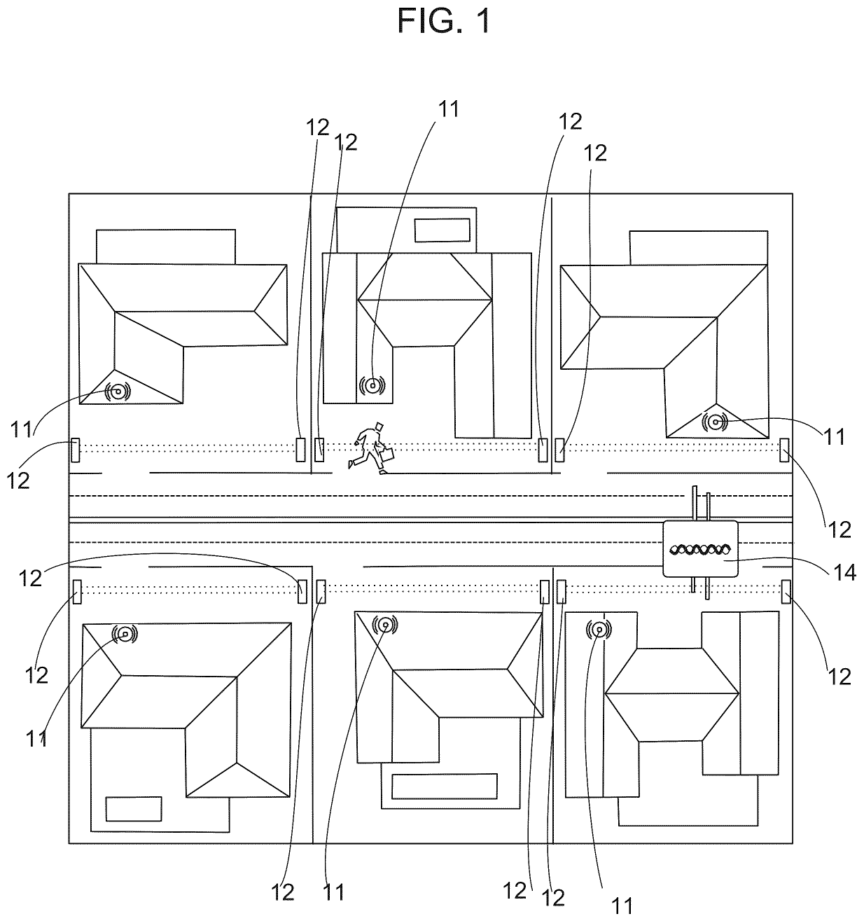

Twin Photobeam Detectors: Installed near property boundaries to detect intrusions by using upper and lower infrared beams.

Outdoor Alarm Sirens: Emit loud sounds to alert neighbors and scare off intruders.

Neighborhood Mesh Network: A secure wireless network connecting all households for coordinated alarm responses.

FIG. 2: Mesh Network Gateway and Local Automation Server

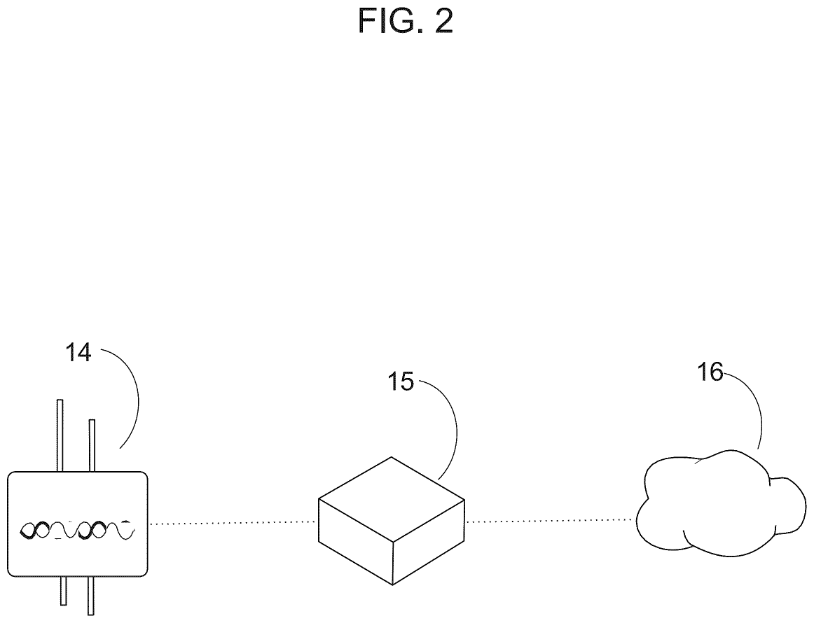

Mesh Network Gateway: Connects security devices to the Local Automation Server, ensuring network communication.

Local Automation Server: Manages the security devices, processes data from detectors, triggers alarms, and connects to the Internet for remote control.

FIG. 3: User Interface for Remote Management

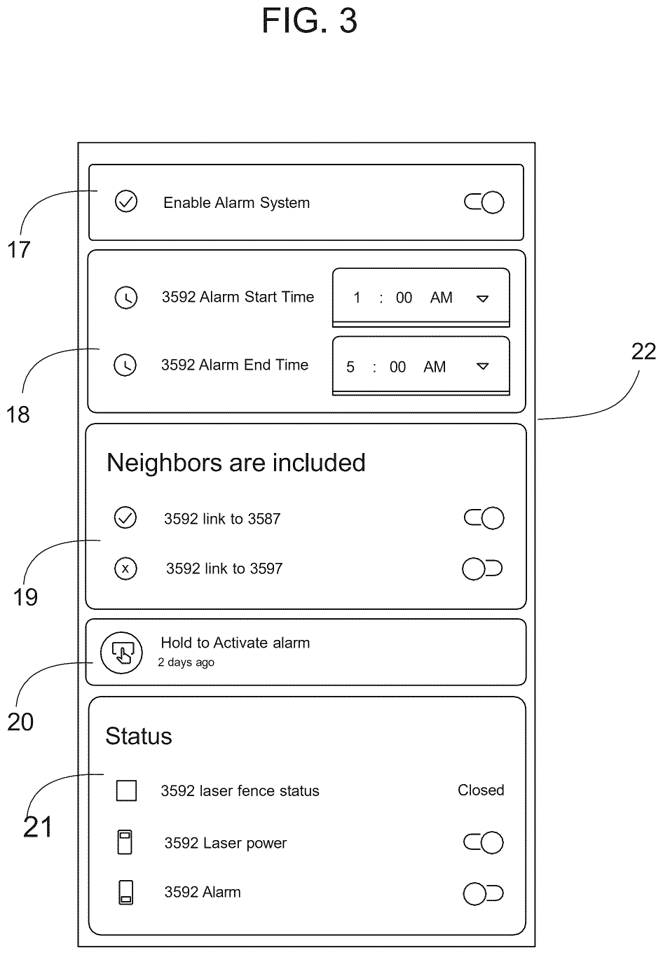

Customizable User Interface: Accessible via web or mobile app, allowing users to manage settings and control the system remotely.

Activation/Deactivation Controls: Enable manual control to turn the system on or off.

Scheduling: Allows setting specific time frames for automatic system activation.

Household Selection: Lets users select which households to link for coordinated alarms.

Emergency Control: Interface option for manually triggering or silencing the alarm.

Coordinated Alarm Activation: Scenario where alarm sirens are triggered across multiple households in response to an intrusion.

### DETAILED DESCRIPTION OF THE INVENTION

### System Architecture and Components

The Neighborhood Alarm Network integrates several key components to ensure comprehensive security and effective intrusion detection. The numbers 10-21 explains each function as labeled in the patent drawings:

### Twin Photobeam Detectors (10)

Installed near the property boundaries, these detectors use upper and lower infrared beams. An alarm is triggered only when both beams are interrupted simultaneously, minimizing false alarms caused by small objects or animals. The twin photobeam detectors are strategically placed to create an invisible barrier that detects unauthorized entry.

### Outdoor Alarm Sirens (11)

Positioned strategically on each household, these sirens emit loud sounds designed to scare off intruders and alert neighbors. The sirens are designed to be loud enough to cover a wide area, ensuring that the alarm is heard by all nearby residents.

### Neighborhood Mesh Network (12)

A secure wireless network that connects the security devices within each household. This network ensures real-time communication between the components of the system, enabling coordinated alarm responses. The mesh network is designed to be robust and resilient, ensuring reliable operation even if some nodes are compromised.

### Mesh Network Gateway (13)

Connects the security devices within each household to the central local server. The gateway facilitates network communication, ensuring that signals from the detectors are transmitted to the server without delay.

### Local Automation Server (14)

Functions as the central hub for controlling and managing the security devices. It processes data from the detectors and triggers the alarm sirens based on predefined conditions. The server also connects to the Internet, allowing for remote management and control via the user interface.

### Internet Connectivity (15)

Enables remote management and control of the security system. Households can monitor and manage their security settings in real-time through a web-based or mobile app interface.

### Customizable User Interface (16)

Provides a customizable interface accessible via a web-based platform or mobile app. This interface allows users to manage their security settings, monitor system status, and control the system remotely. The interface is designed to be user-friendly, ensuring that users can easily configure and operate their security system.

Activation/Deactivation Controls (17) Part of the user interface, these controls allow manual activation or deactivation of the system. Users can turn the system on or off as needed, providing flexibility in managing their security.

### Scheduling (18)

A feature within the user interface that allows users to set specific time frames for automatic activation of the system. This feature ensures that the system is active during vulnerable periods, such as nighttime or when the house is unoccupied.

### Household Selection (19)

Allows users to select which households to link with for coordinated alarms. This feature enables a group of households to respond collectively to an intrusion, enhancing the overall security of the neighborhood.

### Emergency Control (20)

An interface option for manually triggering or silencing the alarm in case of emergencies. This control provides users with the ability to respond to immediate threats or false alarms quickly.

### Coordinated Alarm Activation (21)

Demonstrates the system's ability to trigger alarm sirens across multiple households in response to an intrusion. This collective alert mechanism ensures that the entire neighborhood is aware of a potential security threat.

### SYSTEM OPERATIONS

Upon detecting an intrusion, the twin photobeam detectors send a signal to the local automation server. The server confirms the intrusion and triggers the outdoor alarm sirens across the predefined network of households, creating a coordinated and widespread alert. Users can manage and control the system remotely through the customizable interface, ensuring real-time response and flexibility.

### CUSTOMIZATION AND MAINTENANCE

Households can customize their system settings to fit their lifestyle, including scheduling automatic activation, selecting linked households for coordinated alarms, and setting emergency controls. The maintenance interface allows users to ensure system functionality and perform software updates, maintaining optimal performance and security.

1. A coordinated Neighborhood Alarm Network comprising:
Twin photobeam detectors installed near property boundaries;
Outdoor alarm sirens positioned on each household;
A neighborhood mesh network connecting all security devices within each household;
A mesh network gateway facilitating network communication;
A local automation server processing data from the security devices and triggering the alarm sirens;
Internet connectivity for remote management and control;
A customizable user interface accessible via web or mobile app for managing security settings and controlling the system remotely.

2. The system of claim 1, wherein the twin photobeam detectors trigger an alarm only when both upper and lower beams are interrupted simultaneously.

3. The system of claim 1, wherein the local automation server provides Internet connectivity for remote management and control.

4. The system of claim 1, wherein the user interface allows for customization of system settings, including scheduling, household selection, and emergency controls.

5. The system of claim 1, further comprising a maintenance interface for ensuring system functionality and performing software updates.
